(19) United States
(12) Patent Application Publication
(10) Pub. No.: US 2004/0216385 A1
(43) Pub. Date: Nov. 4, 2004

(54) Seal element for a vehicle component

(76) Inventor: Dieter Raisch, Rutesheim (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/677,547

(22) Filed: Oct. 2, 2003

Related U.S. Application Data
(63) Continuation-in-part of application No. PCT/EP03/02792, filed on Mar. 18, 2003.

(30) Foreign Application Priority Data
Mar. 21, 2002 (DE) 102 12 724.7

(51) Int. Cl. E06B 7/16

(52) U.S. Cl. 49/493.1

(57) ABSTRACT

In a seal element for a vehicle component comprising a seal body delimiting a seal space and the seal body being engaged by the vehicle component when the vehicle component is to be sealed in a closed position of the vehicle component, a reinforcement structure is supported in the seal space so as to be movable relative to the seal body and means are provided for fixing the reinforcement structure in predetermined positions within the seal body.

This is a continuation-in-part application of international application PCT/EP03/02792 filed Mar. 18, 2003 and claiming the priority of German application 102 12 724.4 filed Mar. 21, 2002.

### BACKGROUND OF THE INVENTION

The invention relates to a seal element for a vehicle component with a seal member, which delimits a seal chamber and which, in the sealing position, is engaged by the vehicle component. The seal member includes a reinforcement structure, which is arranged in the seal space and is adjustable with respect to the seal member.

DE 31 41 729 A1 discloses a seal for window panels that can be raised and lowered, particularly side windows of motor vehicles. The seal is attached to a door or a roof frame and includes a seal space closed by a sealing lip which, in sealing position, is engaged by the window edge whereby the sealing lip is deformed and is moved into the seal space. In order to avoid that, particularly at high vehicle speeds, the windows are pulled outwardly because of the vacuum generated by the airflow, which could detrimentally affect the sealing effect, an angular lever is pivotally supported in the seal space of the seal in such a way, that it is pivoted about its pivot axis when the window reaches the seal body and the outer leg of the angled lever is pressed against the window. In this way, a deformation of the seal body, which could detrimentally affect the seal engagement, is to be avoided.

The angled lever includes a pivot joint having a pivot axis about which the angled lever is pivotable. The pivot joint is supported on a metallic support band, which is inserted into the seal body for reinforcing and stiffening the seal body. The metallic support web and the angled lever result in substantial stiffening, and provide for a corresponding reduction of the resiliency particularly in the area of the seal area which is engaged by the window edge. This could detrimentally affect the sealing capability. It is furthermore a problem, that, with a deformation of the support band, the angular lever is no longer engaged by the window in the area of the seal provided therefor but in the area of the pivot joint or even of the opposite leg so that the seal might become totally ineffective.

EP 0 212 901 A1 discloses a seal element for vehicle window panels which includes a seal body with a hollow or seal space and a metal sheet reinforcement structure, which is disposed in the wall of the seal body including the seal space. The reinforcement structure forms an angle with one leg thereof being integrated into the seal body of the seal element and the second leg projecting into the seal space. The reinforcement body is firmly fixed to the seal body so that the position of the leg received in the seal body cannot be changed after the mounting of the reinforcement structure. The possible uses of the seal element are therefore limited to a specific applications.

It is the object of the present invention to provide a seal element for a vehicle component which has good sealing properties and wide use capabilities and which is highly resistant to side forces particularly vacuum forces effective on the outside of the windows of a moving motor vehicle.

### SUMMARY OF THE INVENTION

In a seal element for a vehicle component comprising a seal body delimiting a seal space and the seal body being engaged by the vehicle component when the vehicle component is to be sealed in a closed position of the vehicle component, a reinforcement structure is supported in the seal space so as to be movable relative to the seal body and means are provided for fixing the reinforcement structure in predetermined positions within the seal body.

The position adjustability of the reinforcement structure in the seal body permits the use of the seal body for various applications, as the position of the reinforcement structure can be adapted to a particular design position. On the other hand, the resistance of the seal element, particularly with respect to side forces, which are effective in a direction about normal to the direction of movement of the component to be sealed, is increased. This facilitates the use of the seal element particularly in connection with motor vehicles, specifically for sealing movable side windows, vehicle roofs, etc., wherein a vacuum is generated at the outside at high vehicle speeds by the air flowing over the component. The vacuum forces are effective on the seal element and force the seal element into a non-sealing position. The reinforcement body counteracts such movement and therefore improves the sealing capability of the seal body.

Another advantage over state of the art seal elements is that, in the seal element according to the invention, an additional support strip is not necessary but it may still be provided.

In an expedient embodiment of the invention, the reinforcement structure is slidably supported in the seal body. To this end, in the seal body, preferably in the seal space thereof, a guide element may be provided by which the reinforcement structure is supported so as to be movable over part of its length. The reinforcement structure may be moved linearly as well as rotationally or both at the same time. Rotational or partially circular movement is particularly possible if the reinforcement structure is partially circularly bent. This has the advantage that the reinforcement structure can be moved from a position opposite the engagement surface of the component to be sealed by the seal body into a position sidewardly of the engagement surfaces.

In an alternative embodiment, the reinforcement structure may have a linear shape or at least include linear sections.

The seal body may include a receiver pocket into which the reinforcement structure can be inserted. In this way, an accurate guidance for the reinforcement structure can be provided. Furthermore, the seal wall of the seal body may be pretensioned by inserting a front section of the reinforcement structure under pressure into the receiver pocket. The tension in the wall of the seal body prevents an undesirable sideward movement of the reinforcement structure because of forces effective on the seal element.

Expediently, the seal body may include at least two seal sections of different resistance. In this case, the adjustment arrangement of the reinforcement structure extends advantageously in the same direction as the softer one of the seal sections, so that when the reinforcement body engages the wall of the seal element and is moved along the wall, the softer seal section is elongated or stretched and the respective wall is placed under tension.

The desired position of the reinforcement body at the seal body must be fixed particularly by way of a mounting element which expediently also includes, and/or extends through, the guide element in which the reinforcement element is movably supported for the adjustment to the desired position.

Further advantages and suitable embodiments of the invention will become apparent from the following description on the basis of the accompanying drawings.

### BRIEF DESCRIPTION OF THE DRAWINGS

FIG. 1 shows a seal element in a motor vehicle, which is connected to a vehicle body part and which is engaged by a window panel, and

FIG. 2 shows another embodiment of such a seal element.

### DESCRIPTION OF PREFERRED EMBODIMENTS

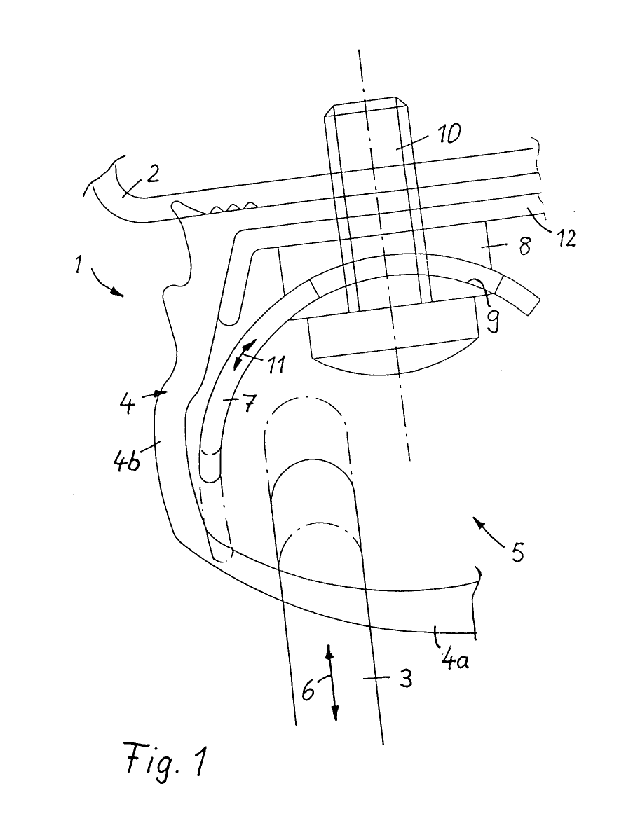

The seal element 1 shown in FIG. 1 is expediently mounted to a vehicle body part 2 and serves for sealing the transition area between the vehicle body part 2 and a side window 3 engaging the seal element 1. It may also be used for sealing another movable part of the motor vehicle, for example, a sliding roof or similar structure. The side window 3 is movable toward, or away from, the seal element 1 in the direction of the arrow 6. The seal element 1 comprises a seal body 4, which fully or partially encloses a seal space 5. A wall section 4a of the seal body 4 extending into the path of the side window 3 forms an engagement surface for the side window 3 and, in the seal position, is deflected into the seal space 5.

The seal element 1 further includes a reinforcement structure 7, which is disposed in the seal space and is movable in the direction of the arrow 11. It can be fixed with respect to the seal body 4 of the seal element in various positions. The reinforcement body consists preferably of a light metal. To facilitate movement of the reinforcement structure 7, a guide element 8 is arranged in the seal space 5 and is provided with a guide track 9, by which the reinforcement structure 7 is slidably supported. For fixing the reinforcement structure 7 in a desired position in the seal space 5, a support element 10 is provided by way of which the seal element 1 is firmly connected to the vehicle body part 2. Expediently, also, the guide element 8 is firmly connected to the vehicle body part 2 by means of the support element 10. In order to increase the stability, a support strip 12 may be provided which may consist of metal and which is arranged in the seal space and abuts the wall section of the seal body 4 facing the vehicle body part 2. The guide element 8 is disposed on the support strip 12.

In the embodiment of FIG. 1, the reinforcement structure 7 has a partial circular shape and is movable within the seal space 5 in the direction of the arrow 11 along a circular path.

The reinforcement structure 7 is to be moved to a position, in which a wall section of the reinforcement structure extends about parallel to a wall section 4b of the seal body 4 in the side area of the seal element 1 next to the wall section 4a, which is engaged by the side window 3. The wall section 4b of the seal body 4 extends in this area about parallel to the side window 3. The wall section 4b forms an outer side of the seal body and is reinforced by the reinforcement structure 7 so that forces effective on the outside of this wall section 4b transverse to the plane of the window 3 do not result in a substantial deformation of the side wall section 4b and the seal element 1 remains fully functional.

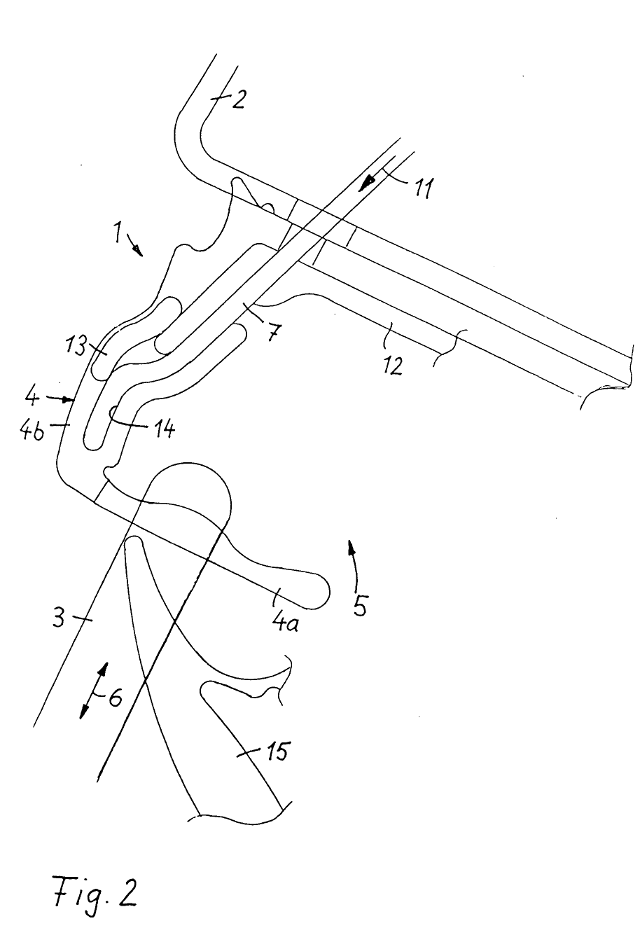

In the seal element as shown in FIG. 2, wherein functionally identical components are identified by the same reference numerals as used in FIG. 1, the reinforcement structure 7 is an essentially linearly extending member which is provided at its front end with an offset end portion. The reinforcement structure 7 may be inserted linearly in the direction of the arrow 11 into a receiver pocket 14, which is formed in the side wall section 4b of the seal body. The insertion opening of the receiver pocket 14 is disposed at the side remote from the wall section 4a which is engaged by the window 3. The insertion direction of the reinforcement body 7 into the receiver pocket 14 is essentially parallel to the direction (arrow 6) of movement of the side window 3. The reinforcement structure 7 is guided by openings in the vehicle body part 3 and in the wall of the seal body 4 as well as by support strips 12 and is movable along those openings in the direction of the arrow 11 and also in the opposite direction. The reinforcement structure 2 is fixed in position for example by a clamping force which is applied to the reinforcement structure 7 from the side thereof by way of the support strip 12 or by way of an additional mounting element which is not shown in FIG. 2.

For stabilization and guidance of the reinforcement structure 7 as shown in FIG. 2, the support strip 12 may also be arranged at the inside of the seal body 4 within the seal space 5.

In the side wall section 4b, there is arranged directly adjacent the receiver pocket 14, a seal section 13, which consists of a softer material than the seal body generally. The seal section 13 is integrated into the side wall section 4b. Because of its greater resiliency, the seal section 13 yields to a greater extent than the surrounding seal material. When the reinforcement structure 7 is inserted in the direction of the arrow 11 into the receiver pocket 14 with a certain pressure so that the front end of the reinforcement body abuts the bottom of the receiver pocket and applies a force thereto, the softer seal section 13 yields to a greater degree than the surrounding wall sections which consist of a harder material. Because of the greater resiliency of the softer wall section 13, the tensions in the seal body 4 are more strictly dependent on the insertion depth of the reinforcement structure 7 into the receiver pocket 14.

Also, the wall section 4a, which is directly engaged by the side window, may consist of a softer seal material than the other wall sections of the seal body 4.

FIG. 2 further shows an additional seal element 15 which may be provided to engage the window 3 from the inside independently from the first seal element 1.

What is claimed is:

1. A seal element (1) for a vehicle component (3), comprising a seal body (4) delimiting a seal space (5), said seal body being engaged by said vehicle component (3) when said vehicle components (3) is in a sealed position, said seal element 1 including a reinforcement structure (7) supported in said seal space (5) so as to be movable relative to said seal body (4) and means for fixing said reinforcement structure 7 in predetermined positions within said seal body (4).

2. A seal element according to claim 1, wherein a guide element (8) is provided in said seal space (5) and said reinforcement structure (7) is guided by said guide element (8) over a predetermined length thereof for movement in said seal body (4).

3. A seal element according to claim 1, wherein said reinforcement structure (7) is circular at least over a part thereof.

4. A seal element according to claim 1, wherein said reinforcement body (7) is insertable in a receiver pocket (14) formed in said seal body 94).

5. A seal element according to claim 1, wherein said seal body includes at least two sections consisting of materials of different resiliency.

6. A seal element according to claim 5, wherein said reinforcement structure (7) engages said seal body (4) in at least one position thereof and a section of material of greater resiliency is arranged in said seal body in the area which is engaged by said reinforcement structure (7) in said at least one position of said reinforcement structure (7).

7. A seal element according to claim 1, including a mounting element (10) for fixing the reinforcement structure (7) in a particular position.

8. A seal element according to claim 1, wherein said reinforcement structure (7) consists of a metal sheet.
